(19) United States
(12) Patent Application Publication
(10) Pub. No.: US 2016/0264218 A1
(43) Pub. Date: Sep. 15, 2016

(54) METHOD OF ATTACHING A FIN ASSEMBLY TO A SURFBOARDING BOARD

(71) Applicant: Thomas Jay Balester, Huntington Beach, CA (US)

(72) Inventor: Thomas Jay Balester, Huntington Beach, CA (US)

(21) Appl. No.: 14/644,168

(22) Filed: Mar. 10, 2015

(51) Int. Cl. B63B 35/79; B29C 65/48

(52) U.S. Cl. CPC B63B 35/793; B29C 65/48; B29L 2031/5272

(57) ABSTRACT

A fin assembly comprises a fin base and a fin blade. Further, the fin base includes a base attachment surface. An attachment area on the bottom surface of a surfboarding board is designated and roughened. Then, an adhesive is applied to the base attachment surface of the fin assembly, and the base attachment surface of the fin assembly is placed over the attachment area on the bottom surface. The adhesive directly and fixedly secures the fin assembly over the surfboarding board.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND

In the early days of surfboarding, surfers would use their back foot to steer in water. The invention of fins revolutionized surfing, enhancing surfers' maneuverability and control in water.

Current methods of attaching fins to surfboarding boards are costly and labor intensive. Further, the fins are embedded in fin boxes fitted into the surfboarding boards, and in case of the fins breakage, during surfing or transportation, the surfboarding boards may also get damaged.

Information relevant to attempts to address these problems can be found in U.S. Patent Application Publication Nos. US20100159759 and US20050287888. However, fin assembly to surfboarding board attachments proposed by each of these references can be weak and prone to breaking

For the foregoing reasons, there is a need for a method to attach a fin to a surfboarding board securely that can be inexpensively applied.

### SUMMARY

The present invention is directed to a method of attaching a fin assembly to a surfboarding board. This invention includes steps that ensure safe and secure attachment of the fin assembly to the surfboarding board, further this method is applied without any cut-outs. This reduces labor costs, complexity of the process, and/or avoids possibility of damage to the surfboarding board in case of the fin assembly breakage.

The present invention provides a method for attaching a fin assembly to a surfboarding board that includes top and bottom surfaces. The fin assembly comprises a fin base and a fin blade that extends away from the fin base, further the fin base includes a base attachment surface. The method comprises the steps of sequentially: (a) designating an attachment area on the bottom surface of the surfboarding board, the attachment area generally matches the base attachment surface of the fin base; (b) preparing the attachment area on the bottom surface of the surfboarding board by employing a means for sanding the attachment area, the sanding means having a grit size from 60 to 180 based on CAMI grit designation; (c) cleaning created dust from the step (b) off the attachment area; (d) applying an adhesive to the base attachment surface of the fin base; and (e) placing the base attachment surface of the fin base over the attachment area on the bottom surface of the surfboarding board.

In certain embodiments of the present invention the fin base may have an oval shape.

A certain embodiment of the present invention comprises a method as described above, and includes the further step, after the step (e), of holding the fin assembly over the surfboarding board by employing an adhesive tape sufficiently long that substantially all the adhesive is cured.

An another embodiment of the present invention includes a method as described above, and further comprises the steps, after the step (a) and before the step (b), of: (i) covering the attachment area with an adhesive tape; and (ii) cutting out an opening area from the adhesive tape so that the base attachment surface fits into the opening area, the opening area is surrounded by the adhesive tape, and the attachment area is exposed through the opening area.

A further embodiment of the present invention includes a method as described above, wherein the fin base and the fin blade are made as separate components, and comprises the further step, after the step (e), of selectively securing the fin blade to the fin base.

A certain embodiment of the present invention comprises a method as described above, wherein the base attachment surface of the fin base includes a concave cavity, and the step (d) further comprises the act of filling the concave cavity with the adhesive.

### BRIEF DESCRIPTION OF THE DRAWINGS

These and other features, aspects, and advantages of the present invention will become better understood with regard to the following description, appended claims, and accompanying drawings where:

FIG. 1 is a side plan view of an exemplary fin assembly used in an embodiment of the present invention;

FIG. 2 is a three dimensional view of the fin assembly of FIG. 1 attached to an exemplary surfboarding board;

FIG. 3 is a side plan view of the surfboarding board and the fin assembly shown in FIG. 2;

FIG. 4 is a three dimensional view of the surfboarding board and the fin assembly of FIG. 2 in an unassembled state;

FIG. 5 is a three dimensional view of the surfboarding board and the fin assembly of FIG. 2 used in another embodiment of the present invention;

FIG. 6A is a three dimensional view of the surfboarding board of FIG. 2 used in another embodiment of the present invention;

FIG. 6B is a three dimensional view of a portion of the surfboarding board of FIG. 6A and the fin assembly of FIG. 1;

FIG. 7A is a side plan view, in partial cut-away, of an exemplary fin assembly used in another embodiment of the present invention;

FIG. 7B is a three dimensional view of the fin assembly of FIG. 7A, in a unassembled state; and

FIG. 8 is a side plan view, in partial cut-away, of a fin assembly and a surfboarding board used in another embodiment of the present invention.

### DETAILED DESCRIPTION

The term “at least” followed by a number is used herein to denote the start of a range beginning with that number. For example “at least 5 minutes” means 5 minutes or more than 5 minutes. When, in this specification, a range is given as “(a first number) to (a second number)” or (a first number)-(a second number)”, this means a range whose lower limit is the first number and whose upper limit is the second number. For example, 60 to 180 means a range whose lower limit is 60 (60 or more than 60), and whose upper limit is 180 (180 or less than 180).

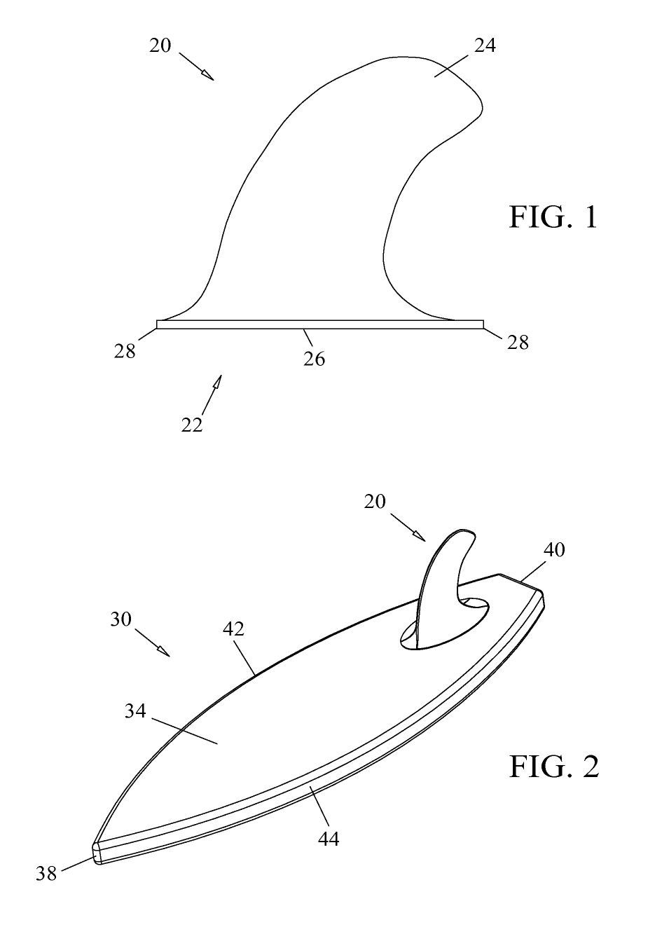

FIG. 1 shows an exemplary fin assembly 20 having a fin base 22 and a fin blade 24 that extends away from the fin base 22, further the fin base 22 includes a base attachment surface 26 and a perimetral edge 28. The fin assembly 20 shown in FIG. 1 is made as a single piece. Alternatively, the fin base 22 and the fin blade 24 can be made as separate components, and selectively connected together.

Moreover, non-limiting examples of suitable materials for the fin base 22 and the fin blade 24 include epoxy, plastics, fiberglass, carbon fiber, and wood.

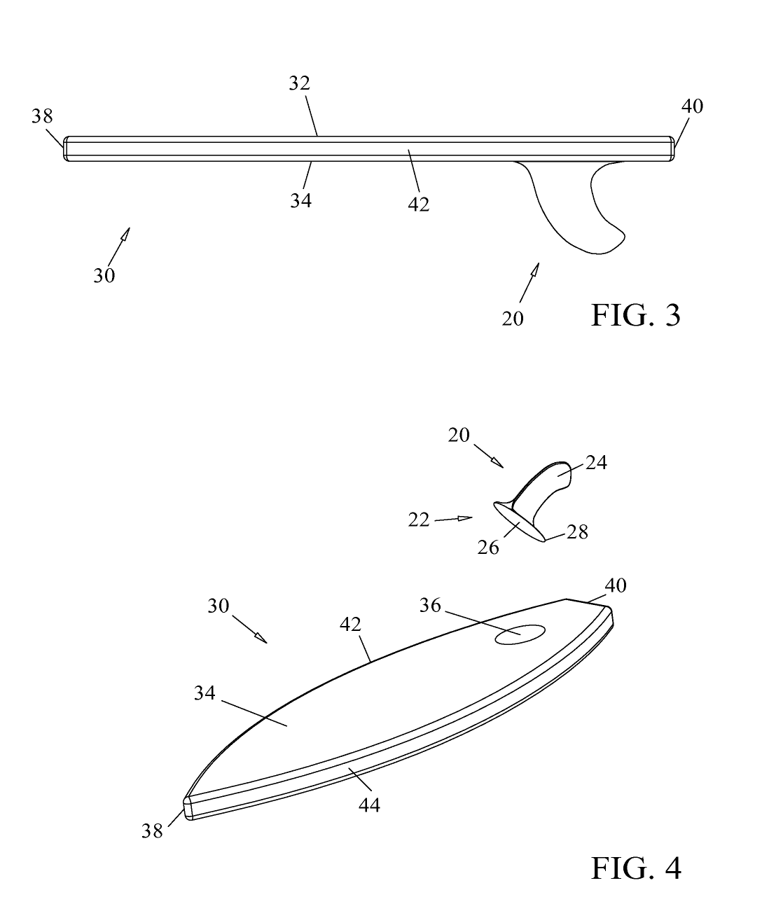

FIGS. 2 and 3 show an exemplary surfboarding board 30 having top 32 (not shown in FIG. 2) and bottom 34 surfaces, a front portion (nose) 38, a rear portion (tail) 40, a left rail 42, and a right rail 44 (not shown in FIG. 3). As it is shown in FIGS. 2 and 3, one fin assembly 20 of FIG. 1 is attached to the bottom surface 34 of the surfboarding board 30. Alternatively, depending upon preference and skill level of a surfer, a plurality of fin assemblies 20 (e.g. two, three, four, or more) can be attached to the bottom surface 34. The surfer stands or sits or lays on the top surface 32, while the bottom surface 34 and the attached fin assembly 20 are directed into water. The top 32 and bottom 34 surfaces are preferably one of a concave, convex, flat, curved, and stepping surface or combination of surfaces.

Most commonly the surfboarding boards 30 are constructed of a polyurethane foam core covered with a fiberglass outer shell. Other non-limiting examples of materials for the surfboarding boards 30 include an expanded polystyrene (EPS) foam core covered in a layered polyvinyl chloride (PVC) and fiberglass composite shell, or the surfboarding board 30 can include wood, carbon fiber, plastic materials and/or resins.

FIG. 4 shows the surfboarding board 30 and the fin assembly 20 of FIG. 2 in a three dimensional view and unassembled state.

A process according to the present invention for attaching the fin assembly 20 to the surfboarding board 30 comprises the steps of sequentially: (a) designating an attachment area 36 on the bottom surface 34 of the surfboarding board 30, wherein the attachment area 36 has a shape and dimensions that generally matches the base attachment surface 26 of the fin base 22; (b) preparing the attachment area 36 on the bottom surface 34 of the surfboarding board 30 by employing a means for sanding the attachment area 36, wherein the sanding means has a grit size from 60 to 180 based on CAMI grit designation; (c) cleaning created dust off the attachment area 36; (d) applying an adhesive to the base attachment surface 26 of the fin base 22; and (e) placing the base attachment surface 26 of the fin assembly 20 over the attachment area 36 on the bottom surface 34, and allowing the adhesive to be cured.

It is obvious that the above mentioned process can be applied to as many fin assemblies as are necessary or desired.

As a non-limiting example, the designation of the attachment area 36 can be fulfilled by utilizing the fin base 22 as a template. In this example, the base attachment surface 26 is placed over a desired location for the attachment area 36, and the perimetral edge 28 of the fin base 22 is used as a guide to mark, with a pencil or marker, the border of the attachment area 36 on the bottom surface 34.

Moreover, the means for sanding the attachment area 36 may be a sandpaper, a power sander, a rotary hand piece, a belt sander, a disc sander and more than one of these in any combination.

The type of the adhesive is compatible with the material of the prepared (sanded) attachment area 36 and the base attachment surface 26. The adhesive creates a strong bond between the attachment area 36 on the bottom surface 34 and the base attachment surface 26 of the fin base 22. As a non-limiting example, the adhesive can be a high strength plastic weld sold by Devcon company, located in Danvers, Mass.

Although it is possible to apply the adhesive to the attachment area 36, to avoid spill of the adhesive over the bottom surface 34, it is preferred to apply the adhesive only to the base attachment surface 26 of the fin base 22. Further, the adhesive covers at least 60 percent of the base attachment surface 26. Preferably the adhesive covers the entire base attachment surface 26.

Generally the untouched bottom surface 34 of the surfboarding board 30 has a surface roughness from 0.21 to 0.25 Ra μm. Mentioned surface roughness gives a smooth texture to the bottom surface 34, and minimizes friction and turbulence when the bottom surface 34 is in contact with water. However, attachment of the fin assembly 20 to the surfboarding board 30 with the adhesive is weak and susceptible to breakage, when the surface roughness of the attachment area 36 is 0.21-0.25 Ra μm. The present invention includes the step of preparing (preparing means sanding) the attachment area 36 with the sanding means that has a grit size from 60 to 180 based on CAMI grit designation. This step is a critical act that roughens the attachment area 36 and increases its surface roughness to about 0.5-1.8 Ra μm. The above mentioned critical step ensures secure attachment of the fin assembly 20 to the surfboarding board 30 with the adhesive.

A process as described above, wherein the fin base 22 has an oval shape. Alternatively, for example, the fin base 22 can be elliptical, circular, or rectangular shaped.

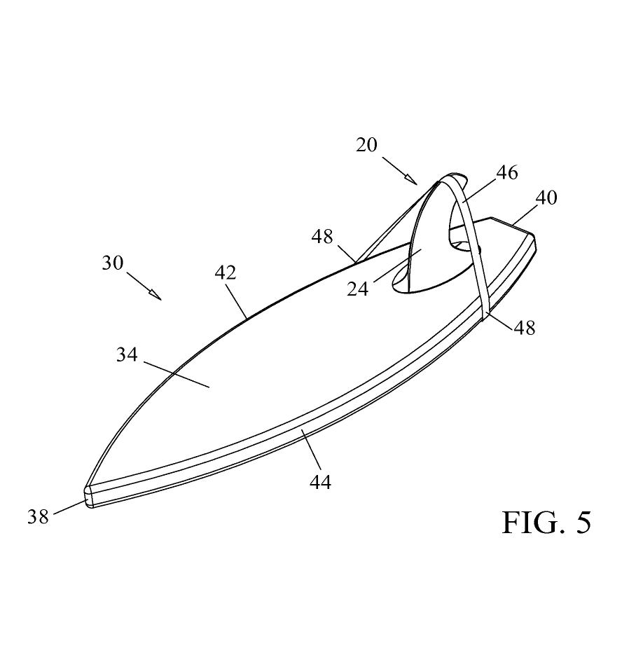

A process as described above further comprising the step, after the step (e), of holding the fin assembly 20 over the surfboarding board 30 by employing an adhesive tape 46 (shown in FIG. 5) sufficiently long that substantially all the applied adhesive is cured. As it is shown in FIG. 5 the adhesive tape 46 includes two ends 48. One of the ends 48 is attached to the top surface 32 (not shown), and the left rail 42; the other end 48 sticks to the top surface 32 (not shown), and the right rail 44; and in an area between these two ends 48 the adhesive tape 46 is affixed to the fin blade 24.

The applied adhesive curing time may vary based on temperature and other environmental conditions. However, in a surfboard workshop it takes at least five minutes for substantially all the adhesive to be cured (preferably 6-8 minutes).

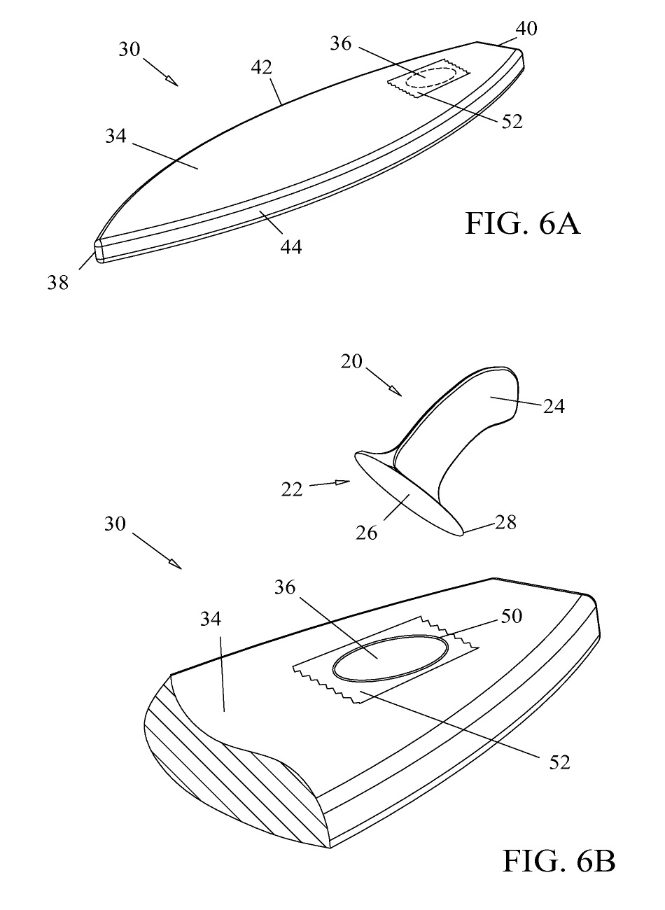

A process as described above further comprising the steps, after the step (a) and before the step (b), of first covering the attachment area 36 on the bottom surface 34 with an adhesive tape 52 (shown in FIG. 6A). Then, cutting out an opening area 50 from the adhesive tape 52 (shown in FIG. 6B). As a non-exclusive example, a cutter or blade can be used to perform the cutting act.

The opening area 50 has a shape and dimensions that allow placement of the base attachment surface 26 over the attachment area 36. Preferably, there is a 1-5 mm clearance between the border of the opening area 50 and the attachment area 36. Furthermore, the attachment area 36 and the opening area 50 are surrounded by the adhesive tape 52, which acts as a guard against spill of the applied adhesive over the bottom surface 34.

As a non-exclusive example, the adhesive tape (46 and 52) can be a multi-surface painter's tape sold by 3M company, located in Minneapolis, Minn.

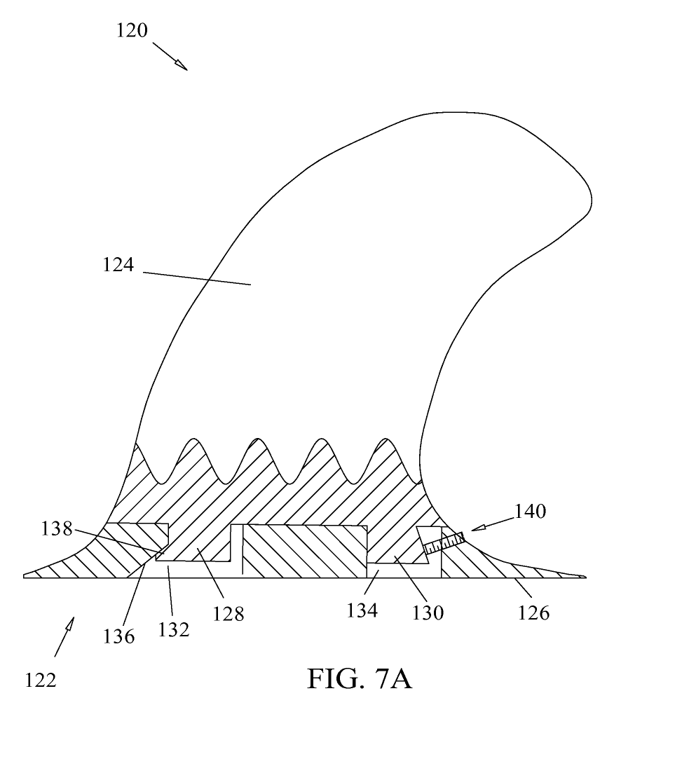

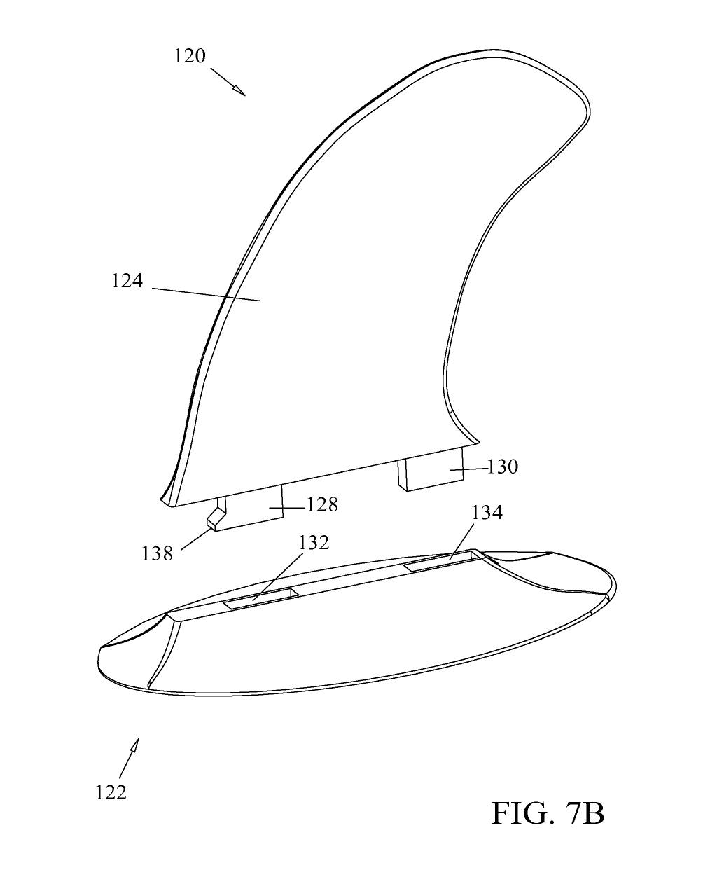

FIGS. 7A and 7B show another exemplary fin assembly 120 used in an embodiment of the present invention. This embodiment includes a process as described above, wherein the fin base 122 and the fin blade 124 are made as separate components. Further, after the step (e), when the applied adhesive to the base attachment surface 126 is cured, the fin blade 124 is selectively secured to the fin base 122 so that the fin blade 124 can be attached and detached from the fin base 122 when required. There can be various ways to selectively secure the fin blade 124 to the fin base 122. As a non limiting example, the fin blade 124 shown in FIGS. 7A and 7B includes front 128 and rear 130 tabs, and there are corresponding front 132 and rear 134 cavities in the fin base 122 to receive the tabs. The front 128 and rear 130 tabs are sized and shaped to fit within corresponding front 132 and rear 134 cavities. Additionally, the front cavity 132 includes a catch 136 and the front tab 128 has a lip 138 that interacts with the catch 136. Moreover, the fin assembly 120 includes a fastener assembly 140 that selectively secures the fin blade 124 to the fin base 122. More specifically, as it is shown in FIG. 7A, the fastener assembly 140 includes a screw that is threaded into a tapped hole in the fin base 122 that engages the rear tab 130 and urges the lip 138 under and against the catch 136. In this example, when the screw is tightened the fin blade 124 can be selectively secured to the fin base 122 and by loosening the screw it is possible to remove the fin blade 124 from the fin base 122.

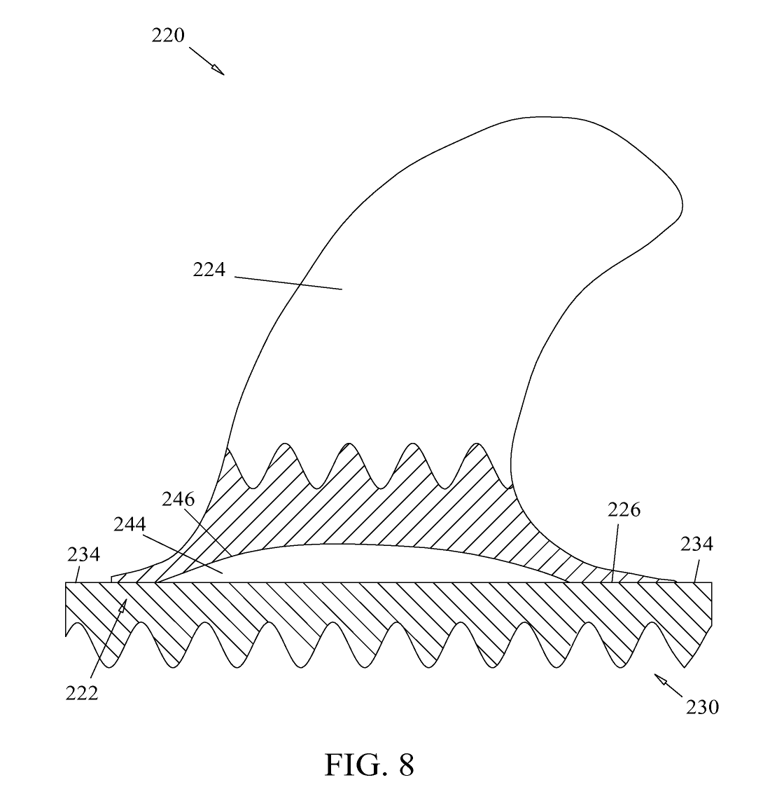

FIGS. 8 shows another exemplary fin assembly 220 used in another embodiment of the present invention. This embodiment includes a process as described above, wherein the base attachment surface 226 of the fin base 222 includes a concave cavity 246, and a chamber 244 is formed between the fin base 222 and the bottom surface 234 of the surfboarding board 230. Moreover, the step (d) further comprising the act of filling the concave cavity 246 with the adhesive. Because of the concave cavity of the base attachment surface 226 more adhesive is applied so the bond between the fin base 222 and the bottom surface 234 can be stronger. Further, the adhesive generally shrinks after it is set and this can produce a vacuum inside the chamber 244, which creates additional adhesion between the fin base 222 and the bottom surface 234.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A method of attaching a fin assembly to a surfboarding board having top and bottom surfaces, the fin assembly comprising a fin base having a base attachment surface, and a fin blade extending away from the fin base, the method comprising the steps of sequentially:
(a) designating an attachment area on the bottom surface of the surfboarding board, the attachment area generally matches the base attachment surface of the fin base;
(b) preparing the attachment area on the bottom surface of the surfboarding board by employing a means for sanding the attachment area, the sanding means having a grit size from 60 to 180 based on CAMI grit designation;
(c) cleaning created dust from the step (b) off the attachment area;
(d) applying an adhesive to the base attachment surface of the fin base; and
(e) placing the base attachment surface of the fin base over the attachment area on the bottom surface.

2. The method of claim 1 wherein the fin base has an oval shape.

3. The method of claim 1 further comprising the step, after the step (e), of holding the fin assembly over the surfboarding board by employing an adhesive tape sufficiently long that substantially all the adhesive is cured.

4. The method of claim 3, wherein the step of holding the fin assembly over the surfboarding board by employing the adhesive tape lasts for at least 5 minutes.

5. The method of claim 1 further comprising the steps, after the step (a) and before the step (b), of:
i. Covering the attachment area with an adhesive tape; and
ii. cutting out an opening area from the adhesive tape so that the base attachment surface fits into the opening area, the opening area is surrounded by the adhesive tape, and the attachment area is exposed through the opening area.

6. The method of claim 1 wherein the fin base and the fin blade are made as separate components, and further comprising the step, after the step (e), of selectively securing the fin blade to the fin base.

7. The method of claim 1 wherein the base attachment surface of the fin base having a concave cavity, and the step (d) further comprising the act of filling the concave cavity with the adhesive.
